(19) United States
(12) Patent Application Publication
(10) Pub. No.: US 2017/0178237 A1
(43) Pub. Date: Jun. 22, 2017

(54) COMPUTER IMPLEMENTED FRAMEWORKS AND METHODS CONFIGURED TO CREATE AND MANAGE A VIRTUAL CURRENCY

(71) Applicant: DRAGONFLY FINTECH PTE LTD, Singapore (SG)

(72) Inventor: Kian Lon Wong, Castle Hill (AU)

(73) Assignee: DRAGONFLY FINTECH PTE LTD, Singapore (SG)

(21) Appl. No.: 15/123,981

(22) PCT Filed: Mar. 10, 2015
(86) PCT No.: PCT/AU2015/000135

§ 371 Date: Sep. 6, 2016

(30) Foreign Application Priority Data
Mar. 11, 2014 (AU) 2014900815

(51) Int. Cl. G06Q 40/04; G06Q 20/36; G06Q 20/12; G06Q 20/06; G06Q 20/38; G06Q 20/10

(52) U.S. Cl. CPC G06Q 40/04; G06Q 20/381; G06Q 20/10; G06Q 20/12; G06Q 20/065; G06Q 20/36

(57) ABSTRACT

Described herein are computer implemented frameworks and methods configured to create and manage a virtual currency bearing characteristics of both a cryptocurrency and fiat money at the same time. The virtual currency bridges the gap between fiat currency of the real world commerce, trade, and finance and cryptocurrency by way of a self-adjusting extrinsic value that is influenced by cross currency exchange rates of fiat currencies. This virtual currency is: relatively agnostic to a volatile global financial condition and has an automatic Global Fiat Currency Grid Normalisation Engine; is autonomous; has no need for arbitration; works entirely on a peer to peer distributed public ledger system (sometimes also known as a block chain) that self-checks, self-validates and secures itself. The virtual currency's mere creation, acceptance and adoption is self-propagating and is a viable solution without the need for any payment gateways, payment processors, payment networks and outdates transaction methods in existence today.

### FIELD OF THE INVENTION

The present invention relates to computer implemented frameworks and methods configured to create and manage a virtual currency. Embodiments of the invention have been particularly developed for creating and managing a virtual currency using computer technology through a process of transforming fiat currencies into a convergent and new instrument for commerce, trade and finance. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

In recent times, there has emerged a new class of digital instruments known as cryptocurrencies (also known as alternative coins, altcoins, cryptocoins, virtual currencies, digital currencies, and often synonymously associated with Bitcoin as the first digital currency).

Wikipedia (as of 5 Feb. 2014) describes a cryptocurrency as follows:

“A cryptocurrency is a digital medium of exchange. The first cryptocurrency to begin trading was Bitcoin in 2009. Since then, numerous cryptocurrencies have become available. Fundamentally, cryptocurrencies are specifications regarding the use of currency which seek to incorporate principles of cryptography to implement a distributed, decentralized and secure information economy. When comparing cryptocurrencies to fiat money, the most notable difference is in how no group or individual may accelerate, stunt or in any other way significantly abuse the production of money. Instead, only a certain amount of cryptocurrency is produced by the entire cryptocurrency system collectively, at a rate which is bounded by a value both prior defined and publicly known.”

In today's business, we are used to having fiat money or currency as a medium of exchange. Fiat money was first introduced almost one thousand years ago in the times of the Song Dynasty in China¹. ¹ http://en.wikipedia.orq/wiki/Fiat_money (24 Feb. 2015)

Wikipedia (as of 5 Feb. 2014) describes fiat money as follows:

“Fiat money has been defined variously as:
any money declared by a government to be legal tender.
state-issued money which is neither convertible by law to any other thing, nor fixed in value in terms of any objective standard.
money without intrinsic value.”

Essentially, fiat money is legislated by the Government and the law of the land. Consequently, fiat currency is created, minted and printed at the request of the Government through a central bank as debt. Hence the economy of the land is more or less controlled and managed by the Government at their discretion. Essentially, fiat money is debt plus interest and is guaranteed by the Government of the land, and therefore the people of the land. Hence fiat money is indirectly borrowed by the people of the land and is owed an interest to which the people of the land must ultimately repay to the central bank. That is public debt. Private debts, most usually based on a fractional reserve banking framework, works in the same way, but at the granularity of individuals of the land. Added together and with interest, the public and private debts more or less represent the entire debt of the land.

On the premise that the Government can order to create as much money as they want, this will lead to the Government, and therefore the people, becoming bankrupt one day in the event that they have no means of paying up. The interests just compound onto one another and the entire borrowed sum and interests continue to escalate until a point where the Government and/or the people of the land cannot pay up. Many countries in recent times, especially in Europe, have required some sort of bailout as a result of too much debt. Portugal, Italy, Greece, Spain, Ireland, and a host of other countries, all faced financial difficulties as a result of too much borrowing and not being able to meet their obligations.

Cryptocurrency was created with the objective of being decentralised in management and independent from any Government (i.e., decentralised and distributed control) and that it should be finite. Having said that, it does not mean we cannot vary the number of cryptocoins. Cryptocoin inflation or deflation can be included into a set of mathematically defined rules that cannot be changed without more than 51% of the majority consensus that are actively involved in the cryptocoin. Entries into the ledger, once confirmed, are immutable. The design is such that the entries in the ledger are checked by what are assumed to be mutually distrustful parties. To ensure that the ledgers are well protected, miners, as they are called, who are members of the public at large, protect the ledgers by way of hashing. In hashing data in a ledger, miners are rewarded with cryptocoins. Hence, they are called miners.

All data are expressed as some binary codes that can be easily “translated” and read off. Hashing is a process whereby this binary coded data is being changed from its original legible value to some other value through the use of a mathematical operation, known as a hashing algorithm. This mathematical operation can be as simple as multiplication, division, addition or subtraction. A desideratum of the hashing operation is that once the original input is hashed, it is nearly impossible to recover without knowing the data used to create the hash value.

With a hashing algorithm put in place, although it is mathematically possible to crack the code, it is almost next to impossible with the amount of computational power we have available now to subvert it. Hashing in cryptocurrency is rather unique. It is a combination of a few processes. In the case of Bitcoin, the first process is to affirm the authenticity of a transaction from the sender to the recipient. It undergoes a hashing process at this stage. Then, along with other transactions in a set time window, they are put together and made into a hashing puzzle whereby miners will try to find a nonce, which is essentially a sequence of numbers with a known input proof, to arrive at a known hash digest output. The first miner to solve the puzzle of finding the nonce gets rewarded. This block of transactions is again hashed by the winning miner to make it an immutable record in the ledger. There exist a few ways of doing this for different types of cryptocurrencies, but in general, it follows the rule of making transactions immutable and therefore irreversible using hashing algorithms.

The value of each cryptocoin is varied. Some of these are based on the premise that miners spend fiat currency to pay for equipment, pay for power costs to run computers and their time involved in mining these cryptocoins. Hence, there should be some value to these cryptocoins for the effort put in by the miners. Some others are based on market demand and supply as they do not cost much to mine them.

The concept is, over time when the distribution of these cryptocoins are more evenly distributed and equitable, the value should be determined by the demand of these cryptocoins to be used for commerce, trade and finance. For non-inflationary cryptocoins, the perceived and accepted value of these cryptocoins should only go up with time on a per unit basis because the numbers are finite.

Fiat money is legal money under regulatory and law controlled by a government. Without control, the Government will not be able to “print” money as they like and essentially be crippled. If Governments are not in control of the issuance of fiat money, they may have to implement higher taxes to finance their operations.

In the state they are in today, most Governments are actually bankrupt and to take away the license to print as well as their control and hold over fiat money would be debilitating to these Governments and could lead to many of them being bankrupt nations. The dire consequence is that it may result in widespread turmoil including civil war and anarchy. The mere creation of cryptocurrencies may well be a catalyst for that to happen.

For a thousand years, history has documented time and again that fiat currency will eventually fail as a medium of exchange and always lead to economic turmoil and war. These include among many, China, France, Germany, Finland, Norway, Italy, Russia, Zimbabwe, Argentina, and Mexico. Today, fiat money is so ingrained in the minds of the populace, that it would be difficult to give up the inherently valueless numbers printed on a piece of paper to signify its value, for anything else whose value is perceived to be less than it.

On the other hand, we have cryptocurrencies that profess to liberate us from our financial bonds. The fact is, a large majority of the population do not know much about cryptocurrencies and they remain as cryptic as they are for anyone to get hold of them and to use them.

Additionally, for those who have the financial strength and know about the existence of cryptocurrencies, they would be loathed to part with their fiat money for these cryptocurrencies. They have the comfort and security of the fiat money and there is no compunction about that; knowing that the Governments are not in support of this initiative and, further, not knowing if the Governments may want to outlaw this as a medium of exchange, will further deter investment into cryptocurrencies. There are obvious signs that many Governments are worried about cryptocurrencies.

The bad publicity given by Governments on cryptocurrencies are just smoke screens. Their reasons include cryptocurrencies being used for financing terrorism, crime and money laundering. Their warnings include calling cryptocurrencies a scam, highly volatile, a high risk, and subject to theft and uncertainty. However, these issues already exist in the world of fiat money. The consistency in the reasons given by Governments and local authorities show that there is no significant truth to the reasons that would preclude cryptocurrencies as a viable alternative to fiat currency. It appears that Governments all over feel that cryptocurrencies are a looming threat to the existing fabric of the financial systems that we are used to.

The entire Crypto community thinks that Cryptocurrencies should be independent and without central control. Their thoughts have been skewed towards using cryptocoins and pegging the value of these cryptocoins to some currency(ies) or commodity. The reality is, why would anyone who is not in possession of these cryptocoins want to follow and accept the way these cryptocoins are valued at? In any case, the price at which they are being traded may not reflect the market demand. There is just not enough out there that is being circulated to create enough depth and liquidity to warrant, say Bitcoin, to be worth $800² a piece. After all, although it is more expensive to mine now, they were initially mined for almost next to nothing and only a small number of people have these cryptocoins. ² https://www.bitstamp.net/ on 6 Feb. 2014.

The number of Bitcoins that are actually in circulation may not be substantial (i.e., a lot of them are being hoarded at the moment rather than being circulated per se and following a normal distribution curve) and the price can easily be manipulated. Bitcoins, in a way, are controlled by a few individuals. In fact, there are less than a quarter million holders³ of Bitcoins at the moment, and a handful have stashed away a substantial amount. It becomes a monopoly of sorts and cannot be accepted by the public at large. ³ http://www.wired.com/wiredenterprise/2013/12/fbi_wallet/ by BY ROBERT MCMILLAN 12.18.13.

The very creation of cryptocoins was meant to be a fair and just system. It is, however, not fool proof, and certain flaws in it coupled by greed and blind faith, which is inherent in human nature, makes it an ideal intention, but not practical as a de-facto digital currency.

The current situation seems to suggest that it will be a long time before cryptocurrency can even be considered as a medium of exchange that is accepted by all. Thus far, this has been a non-starter, inhibiting widespread acceptance, especially by the Governments of this world and the majority of the cryptocurrency have-nots. It will remain a difficult task for all parties concerned for quite a while until there is a proper resolution.

### SUMMARY OF THE INVENTION

It is an object of the present invention to overcome or ameliorate at least one of the disadvantages of the prior art, or to provide a useful alternative.

One embodiment provides a computer implemented method for managing a virtual currency transaction, the method including:
maintaining access to data indicative of a real-currency reservoir, wherein the data indicates values held in each of a defined set of N currencies, wherein at a given point in time, M normalised units are held respectively for each of the N currencies;
receiving data indicative of a transaction in a given one of the currencies Y, wherein the transaction has a value of X in currency Y, wherein the transaction increases the value held in currency Y from M normalised units to M+i normalised units;
determining a series of transactions thereby to balance the real-currency reservoir, such that a portion of the i normalised units of currency Y are converted into others of the N currencies, thereby to enabling automatic balancing of the real-currency reservoir such that M+j normalised units are held respectively for each of the N currencies; and providing an instruction to execute the series of transactions.

In one embodiment X and i are positive values, such that the transaction is a purchase of virtual currency for consideration of X value in currency Y.

In one embodiment X and i are negative values, such that the transaction is a buyback of real currency of X value in currency Y for consideration of virtual currency.

In one embodiment the method includes allocating, in respect of the transaction, a value in virtual currency determined based on a current virtual currency normalised exchange rate for currency Y.

In one embodiment the method includes, for each currency in the set of N currencies, a single normalised unit corresponds to a single integer standard currency value.

One embodiment provides a computer implemented system for automatically pricing a virtual currency unit including:
a real-currency reservoir including data indicative of a defined set of N currencies each having a value, the real-currency reservoir configured to receive input data from a synchronous compensator and provide output data indicative of the pricing of the virtual currency unit with respect to any one of the N currencies;
a sensor configured to retrieve the data value of each of the N currencies from the real-currency reservoir output, and providing the data value of each of the N currencies as feedback in the form of data indicative of a measured sensor output;
wherein the data indicative of the measured sensor output is compared with a corresponding reference data value to provide a measured data error, the reference data value including an absolute or relative re-time data value of each of the N currencies;
wherein the synchronous compensator is configured to receive the measured data error and convert the measured data error into the input data for the real-currency reservoir.

In one embodiment the synchronous compensator uses amplification and filtration to convert the measured data error into input data for the real-currency reservoir.

In one embodiment the real-currency reservoir is normalised to contain an equal number of units and fraction thereof of each of the N currencies, and the number of virtual currency units and fraction thereof is the same as the number of each of the N currencies.

In one embodiment the real-currency reservoir is configured to level the number of units of each of the N currencies following a transaction, such that the number of units of each of the N currencies always remains the same as the number of virtual currency units.

In one embodiment the reference data value is obtained from a control and feedback loop; or a real time and dynamic feed.

In one embodiment the synchronous compensator uses established math or control theory or machine learning or statistical modelling.

One embodiment provides a computer system configured to perform a method as described herein.

One embodiment provides a computer program configured to perform a method as described herein.

One embodiment provides a computer program product for performing a method as described herein.

One embodiment provides a non-transitive carrier medium for carrying computer executable code that, when executed on a processor, causes the processor to perform a method as described herein.

One embodiment provides a system configured for performing a method as described herein.

One embodiment provides a computer implemented financial eco-system comprising:
A. The creation of a new class of financial instrument for commerce, trade and finance;
B. A plurality of computer systems made up of computer hardware (fitted with at least one central processing unit, network card, random access memory, storage media device, graphics card, application software, operating system), routers, firewalls, special purpose appliances, the one or more computer systems configured with specific executable instructions to facilitate the manufacture, operations, sustenance, management, distribution and control of this financial instrument; and
C. A plurality of participants in the computer implemented eco-system, each with their own necessary computer hardware and software, including all users, consumers, merchants, service providers, brokers, financial institutions, providers and distributed gatekeepers of this financial instrument.

In one embodiment the financial instrument in the form of a virtual currency unit (VCU) does not have any central ledger or management system to register its transactions but instead uses a public ledger that is powered by a peer to peer network of computer nodes using a protocol that is used by cryptocurrencies.

In one embodiment a public ledger system, also known as block chain, is being made use of and records are signed, similar to cryptocurrencies, to protect the blocks and records inside the blocks from being doctored with false transaction data for the benefit of any entity and double spending, thereby making all transactions immutable and irreversible.

In one embodiment VCUs are stored in a plurality of virtual wallets that are similar to that used by cryptocurrencies.

In one embodiment the plurality of virtual wallets include all kinds of electronic and/or software storage devices or hard coded prints that allow data indicative of a VCU to be stored and later sent out or exchanged to make a transaction, either physically or electronically.

In one embodiment a transaction of VCUs between parties is by way of using public and private key pairs to sign transactions and of which the keys are generated in similar fashion to that used by cryptocurrencies.

In one embodiment a VCU is substantiated by the extrinsic value of one or more of real world fiat currencies.

In one embodiment these real world fiat currencies are normalised in a Global Fiat Currency Financial Grid (GFCG), with each one of these real world fiat currencies being equal in number to the number of VCUs to be circulated, including any fractions thereof.

In one embodiment the mechanism for normalising these real world fiat currencies in a GFCG is done through a computer program running on a computer system having at least one central processing unit, random access memory, device storage media, a database server, and an operating system all fully networked to a larger system.

In one embodiment each VCU has a value in respect of each of the constituent real world fiat currency in the GFCG.

In one embodiment the mechanism to value each VCU in respect of each of the real world fiat currency in the GFCG is by way of individually determining it through a set of computer programs running on a computer system having at least one central processing unit, random access memory, device storage media, a database server, and an operating system all fully networked to a larger system.

In one embodiment the computer programs comprise:
A. An Accumulator as an internal ledger to manage and control the injection and absorption of fiat currencies from the GFCG;
B. A Synchronous Compensator, using proven control theory techniques or machine learning or statistical models to manage and control the bidding and asking price of each VCU with respect to the cross currency exchange rates of these fiat currencies;
C. The use of a Reference Value algorithm that can be a control and feedback loop itself, or a real time and dynamic data feed, and together with the Output Value from the GFCG to influence the input value to the Synchronous Compensator; and
D. A VCU circulation pool that checks the number of VCUs in circulation through the decentralised and distributed ledger, and then feeds this data back to the Accumulator.

In one embodiment A. further comprises:
A1. The Accumulator acting as a value store, coordinating and checking that all exposed fiat currencies in the Forex Market, the GFCG and the banks are in balance.
A2. The Accumulator matching and balancing the amount of VCUs in circulation and in the value store.

In one embodiment the VCU is used as an instrument for hedging, financial transactions, loans, finance, credits, an instrument of exchange for goods and services, an instrument of use for existing derivatives, an instrument to create new classes of derivatives, an instrument for pricing of stocks, creation of futures, ETFs and stock market, using only VCUs.

In one embodiment the VCU is used as a benchmark financial instrument for fiat currencies to peg to, resulting in a reserve value with virtual presence.

In one embodiment the VCU becomes a financial instrument that can be decoupled from and recoupled with the GFCG, allowing it to run independently, momentarily, temporarily or permanently in either modes.

One embodiment provides a method of distributing the VCU through multiple channels, the method comprising, but not limited to:
A. Financial institutions
B. Brokers
C. Users of VCUs themselves
D. Finance Companies

In one embodiment, transactions between consumers of goods and services with merchants and service providers do not require payment networks, payment gateways and payment processors in carrying out Internet purchases and transactions.

In one embodiment, credit cards can be replaced by using VCU credits extended by Issuing Banks needing no Acquiring Banks but instead dealing directly with merchants and service providers, thus breaking one leg of the value chain, bringing down costs and simplifying credit transactions.

In one embodiment, merchants and service providers link directly with any of the channels to exchange for a fiat currency of their choice.

In short, fiat currencies and cryptocurrencies are at opposite ends of the spectrum. Embodiments of the invention adopt salient features of cryptocurrencies and fiat currencies as a medium of exchange. According to embodiments of the invention, an instrument of exchange or virtual currency that is acceptable by both sides includes the following features:
1) Relatively stable in value, i.e., low volatility;
2) Has similar extrinsic value like fiat money;
3) Easily exchanged for fiat money;
4) Leverages on the use of cryptocurrency technology:
   a) as a means to propagate itself;
   b) for its decentralised, distributed and secure ledger system; and
   c) for ease of transaction;
5) Has a proof check for money flow, i.e., money laundering audit trail;
6) Be somewhat centrally controlled; and
7) Minimal or no change in regulations and frameworks that have been put in place in the current financial industry.

In achieving the above, the apparent fear of money laundering, terrorism, crime, scam, risk and volatility would be addressed. Additionally, this will also help Governments stamp out similar problems related to the use of fiat money, which is also difficult to manage at the moment.

Embodiments of the invention relate to a convergence between the extremes of cryptocurrency being what it is and a centrally controlled fiat currency. The invention, at least in some embodiments, serves to transform fiat currencies into a virtual currency by way of novel computer implementation in converting these fiat currencies so that it is pervasive and self-propagating. The transformation and creation of a virtual currency through computer implementation will be set to change the way we usually do commerce, trade and finance.

Embodiments of the invention use and leverage on existing and new computer related technologies as well as using proven math and engineering control theory to realise its place in the real world of commerce, trade and finance. It is a process that utilises established financial instruments, combines them with computer technologies with the help of proven math and engineering control theory, and harnesses their specific use to give rise or transform them into a new class of instruments. These new virtual currency instruments or units can include the transformation of, but not limited to, stock like instruments, fiat currencies and the various derivative instruments one can find in the financial industry. Computer related technologies used to transform this can include, but not limited to, Internet technologies, proven decentralised and distributed public transaction ledgers that are being used by virtual or digital currencies, computer systems and electronic devices, including smartphones and tablets. Finally, to provide for price control and stability in transforming existing financial instruments into the virtual currency, proven math and engineering control theories implemented using computer system technologies are incorporated into the process.

The convergence of these two distinct and separate types of financial instruments, cryptocurrencies and fiat currencies, with implementation by computer system technologies and the Internet, gives rise to the creation of an amphibious class of service, asset and product that shall be propagated by itself and for itself. It is not a stock. Neither is it a fiat currency nor a digital currency.

This disclosure does not change regulatory frameworks already put in place for financial services and it does not replace the fiat currency. It is not a total replacement of financial institutions nor will it replace the functions of central banks. In addition to being a special class of instrument to be used for commerce, trade and finance, on the contrary, it is a computer implemented process that will also help and complement lawmakers and regulators to manage and monitor commercial crimes, money laundering and, if adopted to the hilt, to monitor all commerce, trade and finance activities with a full audit trail.

The computer implemented process described herein allows for a highly configurable object in form and use. This allows it to assume whatever definition and use it needs to be shaped, far more than what fiat currencies can currently offer. Like the Internet, the end product derived is ubiquitous and knows no boundary. It perpetuates itself across all boundaries and, most of all, it is self-regulatory, very secure and distributed in control and management.

This article of manufacture, in embodiments of the invention, is therefore a new virtual currency that is supported by a global fiat currency grid and created and managed by computer implemented frameworks and methods. This is convergent upon cryptocurrency being a decentralised and distributed system, vis-à-vis a centrally controlled fiat currency that we are used to. Embodiments of the invention are not about “mining” coins but more so about taking the financial world as it exists now and merging it with cryptocoins to create and manage, through the use of computer technologies, a new form of financial instrument that is palatable to all. Embodiments of the invention thus take on the characteristics of:
1. cryptocoins as a decentralised and distributed public ledger system and under control of no single entity;
2. a single global financial instrument;
3. transforming all fiat currencies into a virtual currency by way of implementing a contract to define its value;
4. opening up a plethora of new financial services based on this article of manufacture for commerce, trade and finance;
5. enabling ubiquitous and widespread cross border acceptance using Internet technologies, a well-defined exchange and channels for the purpose of trading and distributing this article of manufacture; and
6. an article of manufacture transforming fiat currencies into a virtual currency with an extrinsic value associated with it.

Most importantly, the end result of the invention is that, it is not academic but will potentially change and transform the way commerce, trade and finance are going to be carried out in the coming years—just like what the mobile phones and Internet did to us erstwhile ago. Additionally, embodiments of the invention are not a matter of fine art but instead, useful art that will have a strong presence and influence in commerce, trade and finance.

This article of manufacture being a new virtual currency, can be designed to be highly volatile and/or highly risky on the one end and highly stable and/or have minimal risk on the other end of the spectrum. Specific to embodiments of this invention is the use of the global fiat currency grid, which can be defined by any number of currencies in the world, to determine its value with the help of a computer implemented synchronous compensator using mathematical, statistical, machine learning or control theory. It can be designed to be highly stable with minimal risk. Provided there is availability of sufficient virtual money, no matter how much this new virtual currency is shorted or longed, its absolute value should remain relatively stable within its standard deviation. The very existence of a fiat currency grid put in place provides for a dampening effect on the volatility of each fiat currency against the virtual currency unit as opposed to the volatility of each of these fiat currencies against each other. In other words, the beta coefficient (being the volatility measurement) of these fiat currencies against one another will be higher than with the virtual currency unit.

The new virtual currency can therefore be made to remain stable and shall not vary much in its value, at least not as much as each of the fiat currencies against one another. It is an instrument that can hardly be used for speculation.

However, external factors that may affect the value of the new virtual currency unit can include incessant printing and distribution of dominant fiat currencies in the fiat currency grid or extreme inflation or deflation in the more dominant fiat currencies.

It uses a decentralised distributed public ledger to keep account of its transactions and therefore opens itself up for any entity, be it an individual, an organisation or a financial institution to own, use and transact with it, all without the worry of double or multiple spending on the same virtual currency unit. Transactions are immutable and irreversible. It can be used as a safe haven for any entity to park its fiat money in times of volatility and global financial crisis, something that is very much in need in these perpetually turbulent conditions we are faced with in recent times. It works on the concept of “water finding its own level”. Notwithstanding printing new money, the entire financial world has a finite value in all their fiat currencies summed together. Added together, there is a “fixed water level” and this new virtual currency fixes that level on a pricing per unit basis. The fixed level is benchmarked against a base datum which is equal units of every currency that is put into the pool.

This new virtual currency unit bases its value on the datum value. Incidentally, many currencies are pegged to a standard set of currencies. As a consequence, this new virtual currency is an average of an average of non-mutually exclusive sets of currencies, effectively unifying all fiat currencies.

This computer implemented creation method of the new virtual currency together with its computer implemented distribution or circulation process makes this new virtual currency unique. This new virtual currency behaves somewhat like fiat currency and yet does not need to be printed or issued, but instead uses a mechanism to match itself with these fiat currencies.

Embodiments of this new virtual currency dispose itself of the need for a new physical currency or any electronic token with some electronic chip to carry its value. All decisions are made by pre-defined rule sets that are rigid, thus getting rid of the need for human decision making, which can be mixed with emotions or irrational logic. Furthermore, its distribution needs no administrative work or central ledger certificate records for each virtual currency issued. It has no electronic tokens and is purely online, although in some embodiments it has a physical electronic wallet specially created for it; however, this is not the only form of value storage. There is no complex portfolio selection and management of financial instruments and their derivatives. The implementation is simple, effective and easy.

This new virtual currency is very much a vector as opposed to a scalar approach. In fact, the approach very much parallels that of electrical power generation. Say, there is a need to put all the world's power into a connected grid. With multiple countries generating electricity using different standards such as different frequencies and voltages, it would be difficult for all of them to come to a common grid unless all three phases are synchronised together in a common frequency and common voltage. Some countries may generate excess capacities. For a country to tap onto this excess capacity and to purchase energy off this grid, it needs to put in place the necessary equipment to convert the energy to suit the local voltage and frequency and synchronises itself to the local grid. This new virtual currency works precisely on that concept. Using computer technologies, it transforms the “Global Fiat Currency Grid” into a virtual currency that can easily be converted into the local currency. It is vector in approach because it synchronises, normalises and combines all the fiat currencies from their individual and scalar existence.

Reference throughout this specification to “one embodiment,” “some embodiments” or “an embodiment” means that a particular feature, structure or characteristic described in connection with the embodiment is included in at least one embodiment of the present invention. Thus, appearances of the phrases “in one embodiment,” “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

FIG. 1 is a relationship diagram illustrating component players in an eco-system that makes use of Virtual Currency Units (VCUs) to do commerce, trade and finance.

FIG. 2 is a diagram showing a Global Fiat Currency Grid Engine (GFCGE) and how this engine will eventually need to couple itself with a VCU Exchange as well as a Foreign Currency Exchange to trade VCU and to balance fiat currencies in a Global Fiat Currency Grid (GFCG).

FIG. 3 is a block diagram showing how a Synchronous Compensator uses mathematically defined engineering control theory to fix the price quotation of VCUs. It is a Closed-Loop Feedback to control the dynamic behaviour of fiat currency exchange rates

FIG. 4 is a diagram showing an Accumulator and how fiat and virtual currencies are being absorbed from or injected into the GFCG.

FIG. 5 is a diagram showing a Global Fiat Currency Grid (GFCG).

FIG. 6 is a table illustrating an example of how the GFCG derives its component contribution from every currency in the GFCG with an initial unitary base and further with 999,999 units injected into the 4-currency Grid as an example.

FIG. 7 is a table showing the quoted price as a result of the initial inputs into the GFCG and basing it on the currency exchange of the four currencies used in the example of FIG. 6.

FIG. 8 is a table showing the instantaneous cross currency exchange rates of the four currencies used in the example of FIG. 6.

FIG. 9 is a table showing the instantaneous reverse cross currency exchange rates of the four currencies used in the example of FIG. 6.

FIG. 10 is a table illustrating an example of an entity selling 50,000 units of VCUs into the GFCG in AUD

FIG. 11 is a table illustrating an example of an entity buying 50,000 units of VCUs from the Fiat Currency Grid in AUD.

FIG. 12 is a table illustrating an example of an entity buying 250,000 VCUs each in the four currencies in the Fiat Currency Grid

FIG. 13 is a table illustrating an example of an entity selling 50,000 VCUs to the Fiat Currency Grid in USD.

FIG. 14 is a table illustrating an example of an entity buying 50,000 VCUs each from the Fiat Currency Grid in SGD and EURO.

FIG. 15 is a block diagram showing how a mathematical function block diagram of a typical PID controller works out its control output. It is one of the many models of control theory that can be used for embodiments of the invention.

FIG. 16 is a diagram showing how the VCU can be managed and controlled through the use of a wallet as well as checking transactions from the public ledger or block chains.

FIG. 17 is a diagram showing the distribution of VCUs through Exchange driven channels.

FIG. 18 is an example of a network diagram showing the solution architecture supporting an eco-system accordingly to an embodiment of the invention.

FIG. 19 illustrates an example of one particular currency in the Global Fiat Currency Grid showing how excess currencies are removed from this bucket into other buckets during normalisation.

FIG. 20 is graph showing how the value of VCU can be adjusted through changes in the Reference Value input.

### DETAILED DESCRIPTION

Described herein are computer implemented frameworks and methods configured to create, manage and facilitate transaction services of a virtual currency.

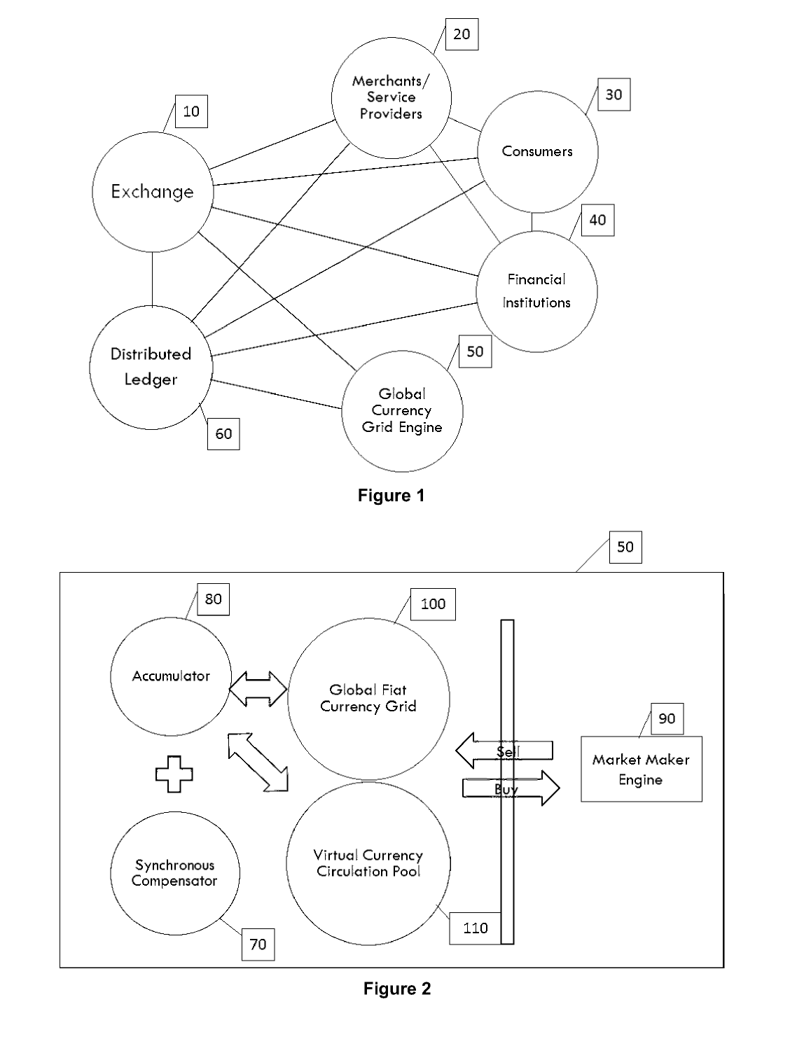

FIG. 1 is a relationship diagram illustrating various important players that make up an ecosphere of a Virtual Currency according to an embodiment of the invention. The various players include: an Exchange 10; Merchants and Service Providers 20; Consumers 30; Financial Institutions 40; a Global Fiat Currency Grid Engine (GFCGE) 50; and a Distributed Ledger 60. In an embodiment, Exchange 10 facilitates trade of Virtual Currency Units (VCUs). Trading of VCUs includes the exchange of data indicative of the VCUs between certain players, for example between Consumers 30 and Merchants and Service Providers 20 via Financial Institutions 40, using specially configured computer technologies. In another embodiment, Global Fiat Currency Grid Engine (GFCGE) 50 manages the supply of VCUs and trades through Exchange 10. Accordingly, Exchange 10, Merchants and Service Providers 20, Consumers 30, Financial Institutions 40, GFCGE 50; and Distributed Ledger 60 are each configured to at least receive and transmit data indicative of the VCUs.

The demand side is represented by Merchants and Service Providers 20, Consumers 30 and Financial Institutions 40. Each of these categories of the demand side has a role to play. Merchants and Service Providers 20 are basically the entities who provide for goods and services to users or consumers 30. Financial Institutions 40 facilitate the ease of doing business between Merchants and Service Providers 20 and Consumers 30. Additionally, Financial Institutions 40 provide other VCU services such as banking, finance, loan, credit, merchant banking and facilitating exchange and other transaction services for both Merchants and Service Providers 20 and Consumers 30. The introduction of VCUs does not disrupt the way commerce, trade and finance are done today but instead can enhance and better facilitate commerce, trade and finance, all these are made possible by the introduction of a GFCGE 50, Distributed Ledger 60, and a necessary specialised Exchange 10 to promote the use of VCUs.

In one embodiment, the Distributed Ledger 60 makes use of computer technologies, and in particular internet technologies to connect gatekeepers, more commonly known as miners, together. Miners sign data and help in protecting the data from being changed or meddled with. Transactions are therefore irreversible and immutable once a set of transactions are put onto the Distributed Ledger 60. The Distributed Ledger 60 is a publicly available ledger that anyone can inspect and use to transact, but cannot amend the contents therein. Distributed Ledger 60 sits on a peer-to-peer network allowing multiple parties to update one another in this network. The Distributed Ledger 60 is replicated by every miner in the peer-to-peer network so that everyone shall have the same exact copy. The Distributed Ledger 60 in this sense, is a trustless decentralised ledger.

The Distributed Ledger 60, also known as a block chain, uses similar technology as that used by cryptocurrencies. Embodiments of the present invention can make use of some, but not limited to the following features:
1. The Distributed Ledger 60 only logs transactions and not balances.
2. Balance checks can be deduced through exploring the Distributed Ledger 60.
3. Distributed Ledger 60 prevents double-spends.
4. Each transaction is serialized.
5. All blocks in the Distributed Ledger 60 are bound together.
6. All nodes subscribe to and validate transactions in the Distributed Ledger 60.
7. All transactions in the chain are consistent and are valid.
8. Double spend attacks require multiple views to verify from different lines in a chain.
9. Distributed Ledger 60 works on the premise that more than 50% of the hashing power of the miners in the chain are honest and not cabals working on cheating the system.
10. Distributed Ledger 60 is likened to a snowball effect, the longer it stays distributed, the harder it is to be attacked.
11. A small transaction fee is given to these miners for signing off transactions.
12. Once set up, no single party can change the rules of the game.

Apart from direct exchange between two willing parties, there are a many ways in which a Consumer 30 can acquire VCUs. One way, in one embodiment, is to go through registered brokers of the Exchange 10 to open up an account and buy these VCUs through direct deposit of fiat money into the account and then using the account to buy VCUs in the local currency where the Consumer 30 is domiciled. This action is similar to depositing money with a broker in stock, derivative or forex trading.

In another embodiment, Consumers 30 can directly access Financial Institutions 40 via traditional banking methods, including Internet banking to purchase VCUs as if they are transferring money from the local currency account to a Forex account. This method of transfer depends on the regulatory framework in which the Consumer 30 is domiciled. Different countries may have different ways of performing transfers of this nature and some of these countries may not allow Consumers 30 to perform transfers of this nature.

In another embodiment, using Credit Card purchase is a method whereby a Consumer 30 can get access to VCUs. In one embodiment, VCUs are used, via Credit Cards, to purchase Goods and Services. These Credit Cards, or “credit VCUs”, are issued directly by participating Banks or Financial Institutions 40 offering VCU payments and credit. Users can eventually pay for these VCUs using traditional fiat currency or choosing to use VCUs.

In another embodiment, consumers “cash out” through Merchants and Service Providers 20 who have VCUs in exchange for fiat currency.

There are many alternative touch points and channels in which VCUs can be obtained. These include, but are not limited to, money changers, specialised Automated Teller Machines (ATM), purpose built vouchers, purpose built electronic wallets with pre-loaded values in it, etc. Suffice to say that the number of channels is limitless.

In one embodiment, in all of these transactions, the Consumer 30 will have to load these VCUs into a virtual wallet. Computer systems and technologies which are specifically configured to load the VCUs into a virtual wallet are used to carry out this function. Virtual wallets include all kinds of electronic and/or software storage devices or hard coded prints that allow a VCU to be stored and later sent out or exchanged to make a transaction, physically or electronically. Virtual Wallets are both online and offline. Online can be offered by various Service Providers 20 or if the Consumer 30 chooses to, he/she can use his/her own online virtual wallet. As aforementioned, all transactions are recorded and validated in the Distributed Ledger 60 which sits on a peer-to-peer network. Hence, whether a virtual wallet is online or offline, it does not matter. Offline is metaphorical because eventually, it still has to go online whether directly or indirectly to synchronise and validate a transaction at some point.

Merchants and Service Providers 20 can sell their goods and services using VCUs. Once the Exchange 10 is established and the eco-system is running, these Merchants and Service Providers 20 can get live streams of exchange rate quotations from the Exchange 10. Prices can then be quoted in VCUs with some tolerance for fluctuations.

On receipt of VCUs for their goods and services, these Merchants and Service Providers 20 can also trade immediately and directly at the Exchange 10 through brokers for fiat money in the local currency or other currency. There is no need for any payment network, gateway or payment processor to do this, and therefore doing away with having to pay fees other than perhaps brokerage fee, which may be very much less compared to that currently charged by payment networks, gateways or payment processor providers.

In one embodiment, a transaction is performed through sending the required VCU amount, that is, transmitting relevant data indicative of the VCU amount, from one virtual wallet (sending party) to another virtual wallet (receiving) using public/private keysets to sign and receive the transaction. A long address consisting of a string of digital codes that are unique to each party is used.

Distinct features resulting from the eco-system according to an embodiment of the invention are:
1. Doing away with intermediaries such as payment networks, gateways and payment processors.
2. Doing away with depositing money in banks as opposed to putting them in virtual wallets.
3. Breaking down the barrier from having to do tedious work in telegraphic transfers for international trade.
4. Instantaneous transfers whether local or cross-borders.
5. Removing some security concerns associated with payments and frauds.
6. Minimal transaction costs.
7. Give rise to new ways of doing commerce such as replacing credit or debit cards with “credit or debit VCUs” and doing away with acquiring banks and the payment network.

The eco-system as herein described makes use of the following combination of technologies in new and improved ways.
1. Cryptocurrency technology.
2. Internet Technologies
3. Computer systems having databases, and specially designed applications and software systems put in place to provide the solutions to be implemented.

In various embodiments, this invention in essence gives rise to a huge computer implemented eco-system wherein the virtual currency, through computers or mobile devices or purpose built electronic devices and machines, is propagated. In an embodiment, the system sits on a network such as the Internet. In an embodiment, participating mining computers communicate on a peer-to-peer (P2P) network on top of this network thereby creating its own distributed and de-centralized network. The decentralized network runs a distributed and decentralised ledger system of which the virtual currency data are continually hashed by the miners, creating an immutable and irreversible ledger of records for the virtual currency.

FIG. 2 is a diagram showing the Global Fiat Currency Grid Engine (GFCGE) 50 in one embodiment. This GFCGE 50 provides the means to change the way commerce, trade and finance are to be carried out. The GFCGE 50 includes five major components: a Synchronous Compensator 70, an Accumulator 80, a Market Maker Engine 90, a Global Fiat Currency Grid (GFCG) 100 and a Virtual Currency Circulation Pool (VCCP) 110.

In an embodiment, the GFCG 100 stores data indicative of a collection of a set of currencies, starting with the most used and recognised major currencies. It should be substantial in value consisting of the major or all fiat currencies in the world put together. The GFCG 100 stores data indicative of one currency at its minimum. The GFCG 100 also includes software configured to execute an algorithm to ensure that the number of each currency is the same as the number of new virtual currencies. With the help of the Synchronous Compensator 70, the GFCG 100 uses data obtained from a live cross currency exchange rate feed from a chosen provider to manage the GFCG 100.

The GFCG 100 is configured to calculate its value through purchasers of the VCUs via the various channels. For each purchase of a VCU from the Exchange 10, data indicative of the value of the fiat currency for this VCU is loaded onto the GFCG 100 and the fiat currency itself is physically transferred to a bank that is closest or most convenient to the transaction via the computer implemented eco-system. The converse is also true, that is, for each sale of a VCU, data indicative of the value of the fiat currency for that VCU gets offloaded from the GFCG 100.

Subsequently, the way the GFCG 100 works is that the data stored in the GFCG 100 is always normalised to contain equal units including fractions thereof of each of the fiat currencies in the GFCG 100. The normalisation process is carried out by specialised software designed to be executed by the GFCG 100. As a consequence of executing the software to carry out the normalisation process, the VCU shall also have the same quantity of units, including any fractions thereof. For example, if each of the fiat currencies has 100.9948624 units, the VCUs shall have the same amount, i.e., 100.9948624 VCUs. This configuration method actually provides a lock on the GFCG 100 system ensuring that the GFCG 100 will never run out of fiat currencies corresponding to the number of VCUs in circulation.

In the event of a sale (meaning, issuing more VCUs) in one particular currency (which is the case as each trade to buy or sell comes in a queue and cannot possibly happen simultaneously), the software included in the GFCG 100 enables the GFCG 100 to adjust itself and brings up to level, the number of fiat currency units in each of the fiat currencies in the GFCG 100. In other words, the additional amount for that fiat currency is evenly distributed to all the rest of the other fiat currencies, so that they all remain at the same level and in line with the number of VCUs in circulation after the sale.

The converse is also true, i.e., in the event there is a purchase (meaning, buying back VCUs from the market), other currencies will be equally distributed to fill the drop in level caused by that particular fiat currency used to buy the VCUs.

The concept is based on “water finding its own level” and, with the aid of a computer system and solution, is fully automatic. Any rise in level in one container will immediately be levelled and filled into the other containers. A drop in level in one container will immediately be filled in and levelled by the rest of the other containers. This way of maintaining the GFCG 100 does not result in many errors. The very fact that they are always at the same level gives it a value that can be determined through a cross currency rate table of all the currencies in the GFCG 100.

In an embodiment, data relating to cross currency rates are transmitted live from a Foreign Exchange and their buy/sell quotations are used to determine the values needed to fill the levels in the GFCG 100 from each sale or purchase of a VCU.

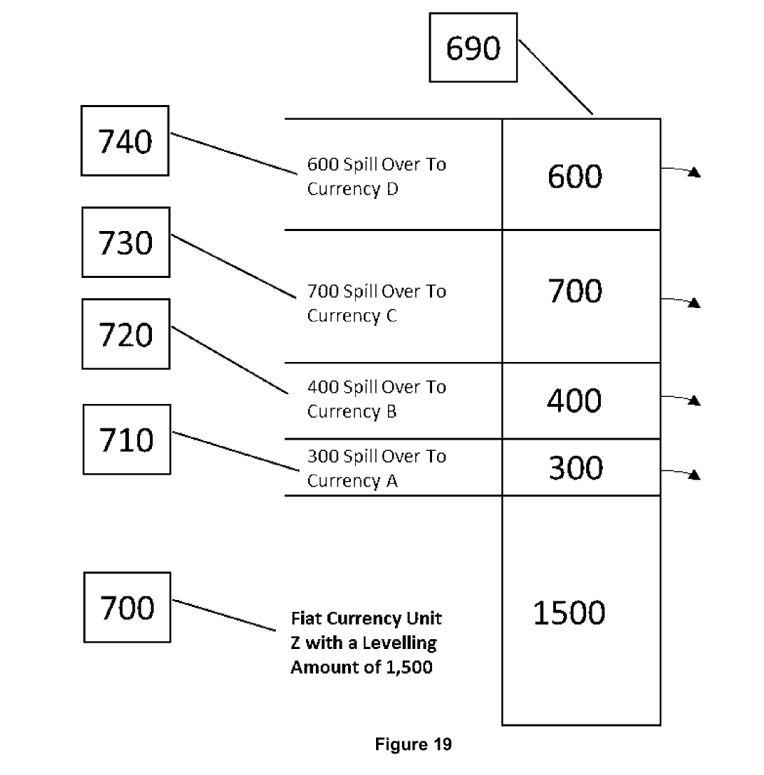

The GFCG 100 when executing software to normalise each transaction, will result in having to immediately execute, in an embodiment, a long or a short position in a Foreign Exchange Spot Market 420 of the currencies affected so as to lock their quantity and values in the GFCG 100 and therefore mitigating any risk of delayed “end of day” exchange consolidation. Referring to FIG. 19, there is illustrated an example of an embodiment, of how a fiat currency unit Z 700 is being normalised. Its levelling amount is 1,500. It needs to remove 2000 units of the currency and distribute the 2000 units into four different other currencies: currency unit A 710, currency unit B 720, currency unit C 730 and currency unit D 740, in their respective quantities of 300, 400, 700 and 600 in the normalisation process. Since it is removing the amount from its bucket, it will therefore need to sell or short this amount in the FOREX Market 420 with respect to each of the currencies, A 710, B 720, C 730 and D 740 in their respective amounts. The converse is also true. There shall only be one forward currency pair for buy and sell for each pair of currency, that is, either M:N pair (selling M for N or buying M with N) or N:M pair (selling N for M and buying N with M) but not both used at the same time. This is necessary to cover open long and short positions of a particular currency pair in the market. The running net position of each currency pair in the GFCG 100 against the actual balances as recorded by Bank Balance Servers 560 and Open positions in the Forex Market 420 should be zero or near zero. The Accumulator 80 includes software, which when executed shall do the necessary final adjustments to ensure that they are all balanced up.

Referring again to FIG. 2, in an embodiment, the Accumulator 80 is a value store and whose function is to balance the GFCG 100. The function of balancing the GFCG 100 is achieved by specialised software executed by the Accumulator 80. In another embodiment, the Virtual Currency Circulation Pool (VCCP) 110 registers data indicative of the number of VCUs in circulation and obtains data indicative of its number from data stored on the block chain or data stored on the Distributed Public Ledger 60, as well as cross checking with Accumulator 80.

Initially, the VCUs are created and data indicative of a predetermined number of VCUs are stored in Accumulator 80 with the actual VCUs being stored in a protected offline virtual wallet or VCU store 230. The initial number of VCUs created will depend on how the operator of this system will want to deploy this initiative. Once created, it cannot be reversed nor added onto. In other words, it shall be fixed. However, with special purpose built rules, this should also be possible to vary in numbers. Fiat currency balance is also stored in Accumulator 80. It is to be noted that the Accumulator 80 is an internal ledger and there is no physical storage of both VCUs and fiat currencies. The Accumulator 80 is not connected to the real world as opposed to GFCG 100 and the VCCP 110, whereas the latter two are live systems that interact with the real world. The Accumulator 80 serves only to balance and check the systems. Additionally, it works hand in hand with the Synchronous Compensator 70 in another embodiment.

The Accumulator 80 always checks on the GFCG 100 and matches it with the VCCP 110. Periodically, it will find that the two will have very small fractional differences as a result of the GFCG 100 computational rounding. This will be compensated by way of injecting or removing fiat currencies into or from the GFCG 100 to balance the differences.

Every time the GFCG 100 is loaded or unloaded with fiat currencies, it undergoes a levelling process as aforementioned. Depending on the Synchronous Compensator 70, there shall usually be excess that will be “swept off” the GFCG 100 and into Accumulator 80. This could be seen as management and transaction fees associated with buying or selling VCUs and contribute to the profitability of the operator as well as additional funds used to balance the differences later.

Essentially, the Accumulator 80 takes off excess or pumps in the requisite amount of fiat currency or virtual currency into the system as determined by the Synchronous Compensator 70, the Exchange 10 and the GFCG 100. It is a reservoir having data indicative of both the virtual and fiat currencies with some data management and software configured to execute a control algorithm. It shall have its own internal accounting and ledger solutions to determine the true excess of funds that shall belong to the operator to cover its operations.

In one embodiment, the Synchronous Compensator 70 uses machine learning or statistical model or control theory consisting of the various types of mathematical theories and engineering science to determine the price quotation of each virtual currency unit with respect to any fiat currency. Essentially, it acts as a modulator to manage and determine the price quotation of the VCUs. Control theory is a branch of engineering whereby the theories, based on some mathematical theories are used to manage an output as a result of a feedback (or multiple feedbacks) that are being received. It is a theory used in engineering and has many approaches to it in order to achieve optimum performance for each particular case. In the present invention, the application and implementation of these theories are used to manage various data and data output specific to the needs of the computer implemented system.

The entire GFCGE 50 shall be operated offline. Offline, in this context, means that it is not directly connected online and uses another layer of server hardware to indirectly obtain data and information from the Internet or network. Consequently, in an embodiment, the worked out price quotation is determined, fixed and streamed into the Exchange 10 via the Market Maker Engine 90 and as a frontend layer of server hardware. Its price is already determined by the cross exchange rates of each of the fiat currencies in the GFCG 100 and synchronously compensated by the Synchronous Compensator 70. The GFCGE 50 therefore, has a market maker function. There is therefore, not much point in trading with this VCU per se as it limits the scope of speculation and profiteering. Having said that, it can still be traded upon, albeit the margin of profit or loss can be small. In an embodiment, it serves as a tool for commerce, trade and finance, that is, using it as a reserve instrument in lieu of fiat currency, transacting in VCUs, using it to hedge, extending loans with it, using it as an instrument for existing and new derivatives, stocks transacted and quoted in VCU, and trading using VCU, credit, finance and leasing. In fact, it can do everything and more than what fiat currency can do. It is a superset of the fiat currencies.

As most of the GFCGE 50 components are mostly offline in operation, there is little chance that the system can be subject to hacking and manipulation. Designed well, it is in fact very safe and is almost fool proof as a solution.

The Synchronous Compensator, 70, fixes the price quotation. The Market Maker Engine (MME) 90, actually manages these pricings by placing them onto the Exchange 10 for orders to buy and sell in the market. The MME 90 essentially determines the market price of these VCUs in the Exchange 10 with the help of the Synchronous Compensator 70. Upon execution of specific software, the MME 90 updates the GFCG 100 and the Accumulator 80. Additionally, the MME 90 gets updated with real time cross currency exchange rates directly from the Forex Market 420.

The very existence of the Synchronous Compensator 70 and the GFCG 100 and the flexible algorithm they can have, whether simple or complex, gives rise to a highly sophisticated engine for the transformation into, management of and control of the circulation of the VCU. The Synchronous Compensator 70 allows for the definition of pricing of each VCU, including making it volatile (or not) and decoupling the entire VCU domain from the fiat currency domain.

The Synchronous Compensator 70 can have a null reference input, i.e., having a system output of 1, and allows the GFCG 100 to work on adjusting its value. This is the simplest and most natural process, but could run into a deficit. The buy and sell price can also be set at a fixed premium over the true value of the price of one unit of virtual currency that is determined based on the cross currency exchange rates by the Forex Market 420. However, the dynamics of fiat currencies do not allow such a simple process to happen. Pricing relationships may be non-linear and random, depending on the socio-economic and political situation in each country and between countries together with the influence they can have on the world. With this Synchronous Compensator 70 put in place, it basically treats these influences as “plant noise” and acts accordingly based on mathematical control theories to control its pricing.

The Synchronous Compensator 70 can be adjusted with a bias to determine a flexible premium as well as fixing the price of the value of one unit of virtual currency and in so doing, maintain the stability of the system. This allows the operator to control the value of the price of one unit of virtual currency. Even one basis point difference can prove to be very substantial. The Synchronous Compensator 70 and the GFCG 100 are real time systems and work on the fly.

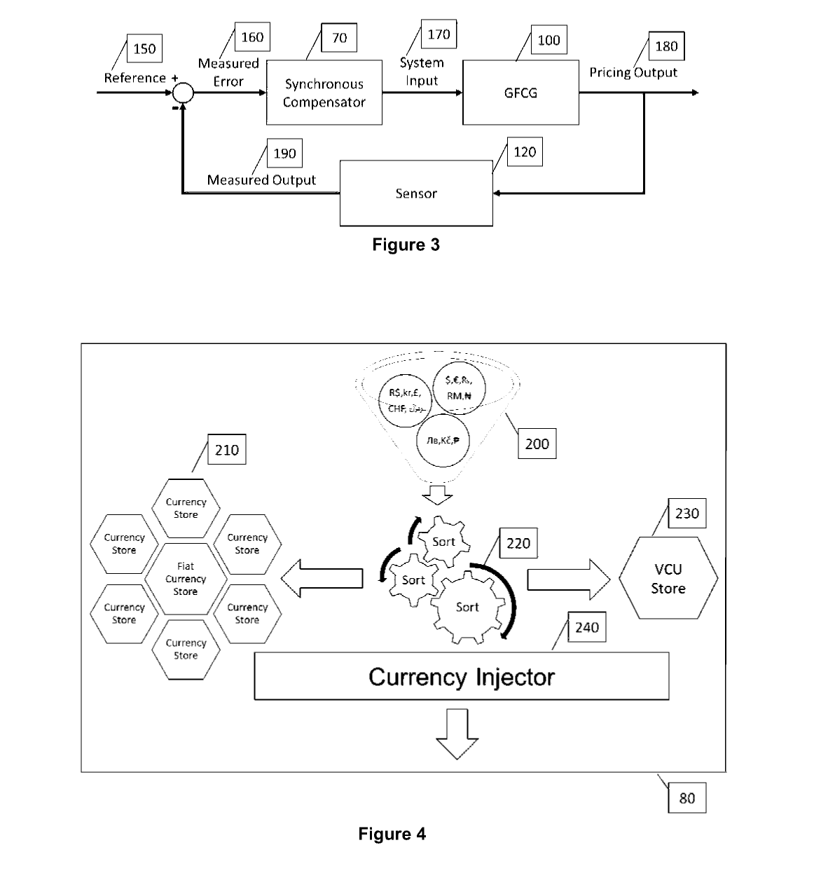

FIG. 3 is a diagram of a closed-loop feedback control solution which is computer implemented as the engine to the pricing of the VCU, and whose dynamic behaviour will be very much influenced by cross currency exchange rates that change all the time. Fiat cross currency exchange rates are determined by the market and is a very mature market. It can react very extremely to market conditions. However, its overall change as part of the GFCG 100, is not very much affected because fiat currencies when they change in value, will go up or down against one another, depending on which side that currency is in. In the end, they may just end up overall not changed substantially in the GFCG 100. A substantial change can happen if a country prints money indiscriminately and whose currency's weighting in the GFCG 100 is also substantial. However, the impact in the GFCG 100 will not be as substantial as the impact between fiat currencies.

A Sensor 120, Synchronous Compensator 70, and GFCG 100, in one embodiment, form the basis of the Sensor, Controller and System components in control theory. The fundamentals of closed-loop control systems require that there is feedback from the output of a system or plant back into a controller through a sensor and that the system or plant's output is the parameter to be controlled and moderated. The Synchronous Compensator 70 is the Controller that does the amplification and filtration of a Measured Error 160 which is fed back by Sensor 120 in a Measured Output 190 against a Reference value 150. The System Input 170 to the GFCG 100 determines the Pricing Output 180, that is, the pricing of VCUs. The end result is thus, the price quotation of VCUs to be streamed into the Market Maker Engine 90.

The objective of the Synchronous Compensator 70 is to make use of the Reference value 150 being data indicative of a real-time absolute or a relative value of each particular fiat currency that the GFCG 100 deals with for every transaction and then transforms it into data indicative of a price to be quoted through the Market Maker Engine 90.

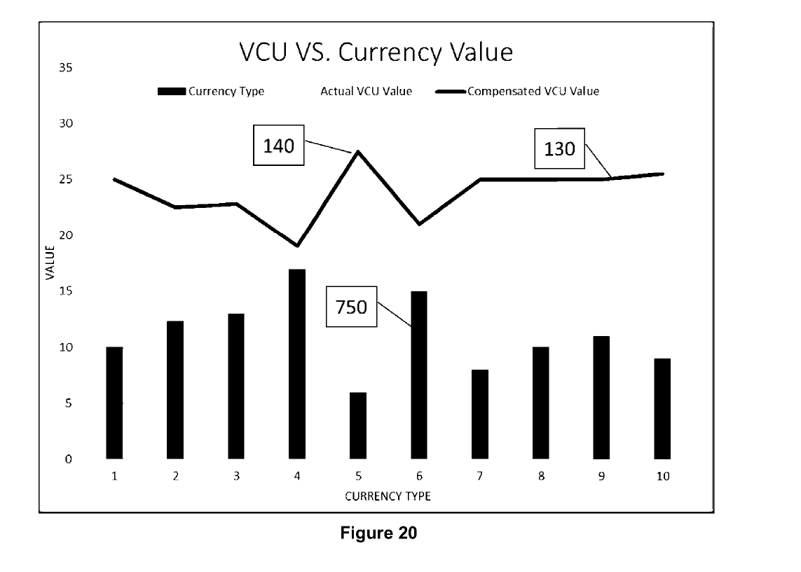

It should be noted that the Reference Value 150 itself is a dynamic value, resulting in a multiple input system and hence may itself be a control and feedback loop. For example, the Reference Value 150 can derive its absolute or relative value of a particular currency and base it on the highest/fastest rising or falling exchange rate of a currency. Or it can totally ignore that and work using only a simple formula. Referring to FIG. 20, a graph is illustrated showing the price relativity of each component currency 750 against one another on a bar chart. For example, currency type 6 is about 1.5 times the value of currency type 1. FIG. 20 further shows how, with the influence of the Reference Value 150, the general relative pricing of the VCU with respect to each currency type can be adjusted or compensated as shown by Curve 130. Otherwise, if allowed to take a normal course, it could end up like Curve 140. Suffice to say that the Reference Value 150 can take on a very sophisticated algorithm.

The fiat cross currency exchange rates are determined by market forces and therefore changes every so often. These cross currency exchange rates are therefore dynamic. For each fiat currency, this will constantly change against one another. In control theory, this is known as system or plant noise that disturbs the equilibrium of the output. Referring again to FIG. 3, the computed Reference Value 150 is compared against the feedback for every currency in the GFCG 100.

The control theory in its simplest form, assuming the Synchronous Compensator 70, GFCG 100 and Sensor 120 are time invariant and linear, can be analysed using the Laplace Transform on the variables.

Given the following:

### 1. Synchronous Compensator 70, is C(s)

### 2. Sensor 120, is F(s)

### 3. GFCG 100, is P(s)

### 4. Reference 150, is r, R(s)

### 5. Measured Error 160, is e, E(s)

### 6. System Input 170, is u, U(s)

### 7. Pricing Output 180, is y, Y(s),

8. Measured Output 190, is m, F(s)*Y(s), then
We have the following relations:

Y(s)=P(s)*U(s)

U(s)=C(s)*E(s)

E(s)=R(s)−F(s)*Y(s)

Solving for the Pricing Output 180, Y(s), we have:

$$Y ( s ) = ( \frac{P ( s ) C ( s )}{1 + F ( s ) P ( s ) C ( s )} ) R ( s ) = H ( s ) R ( s )$$

Hence, the expression

$$H ( s ) = \frac{P ( s ) C ( s )}{1 + F ( s ) P ( s ) C ( s )} ,$$

is known as the closed-loop transfer function of this system. The numerator is the gain if there is no feedback, i.e., open-loop control where F(s)=0. In other words, the numerator is the forward gain from r to y.

The denominator is 1+the forward gain multiplied by the Sensor function, i.e., known as the loop gain.

If |P(s)C(s)|>>1, and if |F(s)|≈1, then Y(s)≈R(s). Hence the output shall closely track the Reference Value 150. It can be seen from here that H(s) is very much influenced by F(s) and therefore, the Measured Output 190. A wildly swinging random Measured Output 190 will result in H(s) reacting the same to compensate for this change. And this is largely compensated by C(s) which is the only variable that can counteract F(s).

The controller function, which is the Synchronous Compensator 70, can be made to be very sophisticated, therefore giving a very close approximation of the Pricing Output 180 to the Reference Value 150.

In one embodiment, a Proportional, Integral and Derivative (PID) controller is used for the Synchronous Compensator 70. PID has reference to the treatment of the Measured Error 160, and is used to produce a control signal or the System Input 170.

In an embodiment, given that the Measured Error 160 e(t)=r(t)−y(t), the System Input 170 u(t) of a PID controller is expressed as:

$$u ( t ) = {K}_{P} e ( t ) + {K}_{I} \int e ( t ) dt + {K}_{D} \frac{d}{dt} e ( t )$$

Applying Laplace Transformation, the transformed PID equation becomes

$$u ( s ) = {K}_{P} e ( s ) + {K}_{I} \frac{1}{s} e ( s ) + {K}_{D} se ( s )$$

$$u ( s ) = ( {K}_{P} + {K}_{I} \frac{1}{s} + {K}_{D} s ) e ( s )$$

From the above, C(s), the controller transfer function for Synchronous Compensator 70 is therefore:

$$( {K}_{P} + {K}_{I} \frac{1}{s} + {K}_{D} s )$$

To achieve the desired output, the three parameters K_{P}, K_{I} and K_{D} are iteratively tuned. To achieve stability, the proportional term is used. To reject a sudden surge or step volatility, the Integral term is used. Finally to damper or to shape the response, the derivative term is used. Combined, they give the overall system the control that is required. PID controllers by far are simple and have been the most widely used controllers for reactive control.

The foregoing is only one embodiment and is just one controller theory, being PID that is used to illustrate the Synchronous Compensator 70. Many other forms of control theories can be explored, including using machine learning and statistical models for this Synchronous Compensator 70 to achieve the best instantaneous result. Suffice to say that this invention uses an embodiment in control theory that is based on engineering mathematics to define the Synchronous Compensator 70 for the most optimum response to the market dynamics of cross currency exchange rates. Whether it is PID controller theory or model predictive control or stochastic optimal control or even a simple mathematical function, the Synchronous Compensator 70 is well defined as a function to be used for the purpose of optimising the Pricing Output 180. In other words, the Synchronous Compensator 70 is a black box function suitably fitted with a simple or complex mathematical function that is used to influence the desired value of the Pricing Output 180.

Referring to FIG. 15, if the Synchronous Compensator 70 is based on the closed-loop PID control theory then:
1. The Set point 610 is the reference factor used to take off excess fiat currencies from the GFCG 100 into the Accumulator 80.
2. The process 670 “disturbance” is the change in VCU pricing in a particular fiat currency as a result of changes in cross currency rates.
3. The output 680 as a result of the disturbance is the feedback used to subtract in the summation 630 with the reference Set point 610 to obtain the error input 620 into the controller for re-computation.
4. The output of the controller is a summation 631 of the Proportional 640, Integral 650 and Derivative 660 component results that are fed into the Process 670 to create a new Output 680 that should be closer or equal to the Set point 610.

The PID controller u(t₁) adjusts the output based on a disturbance value d(t₁). It however does not predict what will happen at d(t₂). The model predictive control or the stochastic optimal control attempt to do just that.

The various pricing models of the VCU as described above are in each case implemented using computer technologies.

FIG. 4 is a diagram showing the Accumulator 80. It shows how excess fiat currencies are “swept off” the GFCG 100 and funnels 200 through into their respective fiat currency value stores via a sorting 220 engine. The Accumulator 80 store is actually an internal ledger, accounting for all transactions in the GFCG 100. It retrieves or adds data indicative of the VCUs into the VCU store 230. If there is a market short on the VCU, the VCU store 230 “retires” data indicative of this VCU. The converse is true, that is, the VCU store 230 releases data indicative of the VCU back into the VCCP 110.

The Accumulator 80 is not just a value store. Its sort function 220 actually does accounting for all the fiat currencies actual balances in the banks in which the VCUs are traded. The Accumulator 80 includes software, which when executed reconciles what is in the Fiat Currency Store 210 and the GFCG 100 with the bank balances as well as the open positions in the Forex Market 420. It does reporting on the amounts that are exposed in the real world for all the fiat currencies in the GFCG 100. The GFCG 100 works on the premise that every unit of fiat currency in the GFCG 100 is matched with an equal amount of another fiat currency, and so on. However, in the bank balances, unless they are actively balanced, this is not the case. Hence, there are risks associated with this exposure that are mitigated and negated by trades that are in open positions in the Forex Market 420 in real time. The sort function 220 is important here to keep track of the exposure of these currencies in the banks, Forex open positions and Fiat Currency Store 210 and provides for an actual real time dashboard overview. In addition, the sort function 220 also injects fiat currencies into the GFCG 100 through a Currency Injector 240 process. Whilst no actual money is physically injected, the sort function 220 actually moves data indicative of balances between Fiat Currency store 210 and the GFCG 100 accounts within the Accumulator 80, which then keeps track of how much money is supposed to be apportioned and to which bucket. In this embodiment, the end results of the Accumulator 80 is that it includes software configured to:
1. Keep track of how much fiat currencies have been taken off the GFCG 100.
2. Keep track of the exchange exposure of each fiat currency in the banks.
3. Keep track of the running balance that should be in the GFCG 100.
4. Keep track of how much VCUs there are in the VCU store 230 and VCCP 110.
5. Keep track of the open positions of Forex trades in the Forex Market 420.
6. Carry out reporting activity and acts on what currency should be converted and into which currency.
7. Coordinate and making sure that the right amount of VCUs circulated correspond to the GFCG 100.
8. Produce analysis reports on expected risks involved with the entire GFCG 100 with respect to the overall position.
9. Ensure that the books are all well balanced.

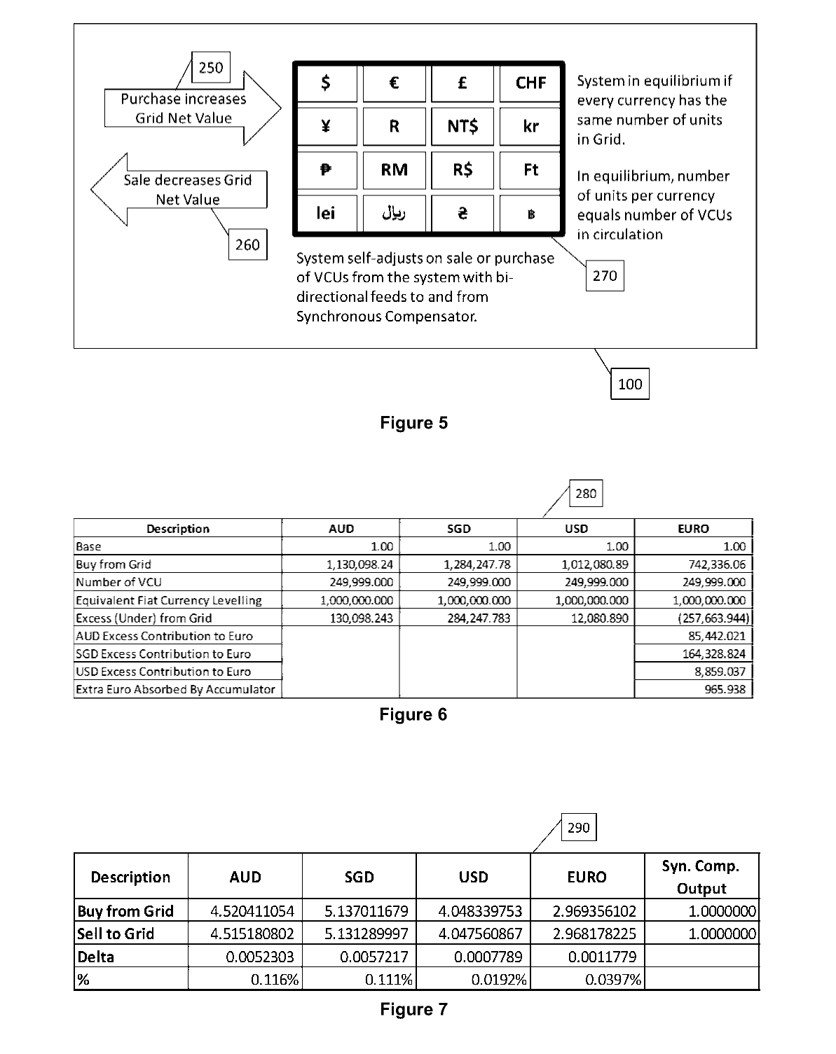

FIG. 5 is a diagram showing the GFCG 100, according to one embodiment. This is where all the different types of fiat currencies shall be put into the GFCG 100. In the initial stage, only data indicative of the more popular fiat currency types are introduced and used in the GFCG 100. Having said that, it is important to note that there must be a minimum number of fiat currency types in the initial GFCG 100 so that adding missing fiat currencies in the future will not disturb the pricing of the VCU substantially. The number of fiat currency types to be included will actually depend on how much tolerance on the volatility of the VCU is going to be when a missing fiat currency is added in the future. There shall be no volatility of the VCU if all the fiat currencies are included in the initial stage. Alternatively, we can have multiple types of VCUs consisting of multiple combinations of the types of fiat currencies, each running independently of one another.

The GFCG 100 will have on its Grid 270 data indicative of similar numbers of each fiat currency in each slot of fiat currency, starting with 1 unit of each as the base datum reference point. The overall Grid Net Value of the GFCG 100 increases in value if there are Purchases 250 of VCUs from the GFCGE 50. The converse is true for Sales 260 of VCUs into the GFCGE 50.

The GFCG 100 includes software that automatically adjusts the number of units in each of the fiat currency units in the buckets in the event of a Purchase 250 or Sale 260. Additionally, based on the available cross currency exchange rates of these fiat currencies, and with the help of the Synchronous Compensator 70, the GFCG 100 generates data indicative of the prices of each of the fiat currencies with respect to the VCUs to be fed into the Sensor 120 to compute the Measured Output 190. The System Input Value 170 from the Synchronous Compensator 70 together with the last quoted price becomes the new quoted price of the VCU with respect to each of the fiat currencies.

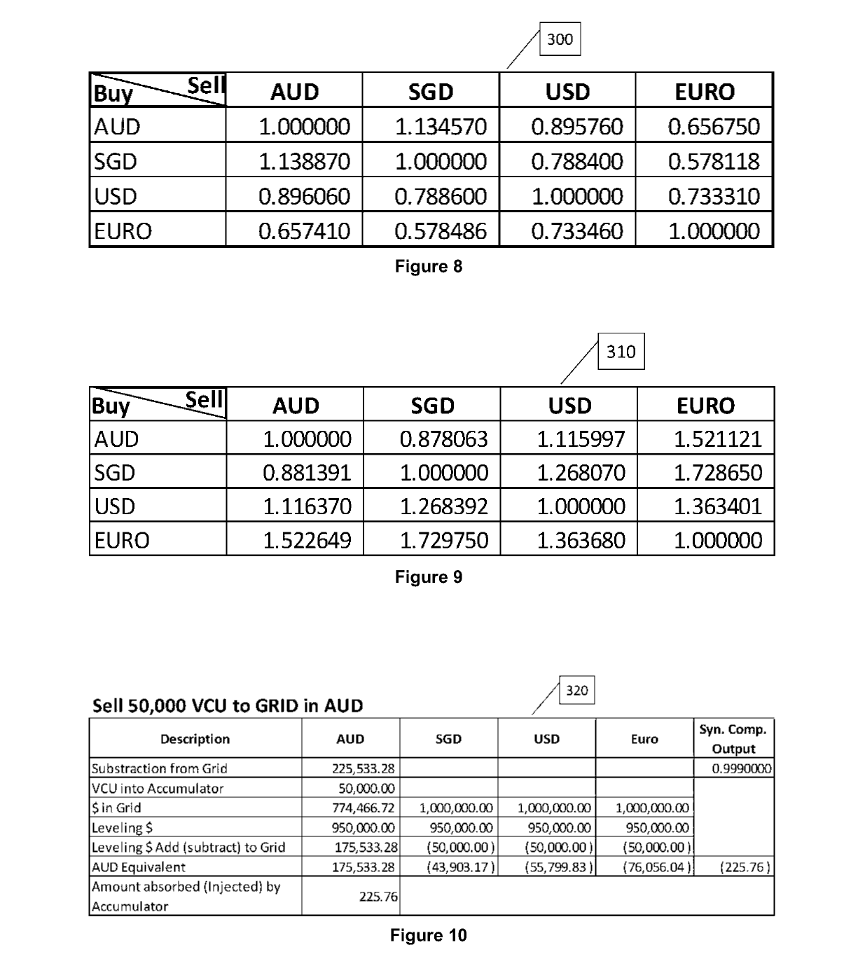

FIG. 6 shows a case example with only four fiat currencies. The basis is the same if we expand to any number of fiat currencies available. The GFCG 100 at its datum value is 1 each of Australian Dollar (AUD), Singapore Dollar (SGD), United States Dollar (USD) and the EURO. Added together, and using the Forward 300 and Reverse 310 exchange rates as respectively shown in FIG. 8 and FIG. 9, the price per VCU for each of the above currencies is as shown in FIG. 7.

If we increase the number of VCUs by 249,999 for each currency, the total number of VCUs released into the VCCP 110 is therefore 1 million. This means that the fiat currency of each of the four will have to be increased by 999,999, so that they are levelled with the number of VCUs in circulation. The increase will always balance out with respect to the exchange rates. In this case, the EURO is short, but because there are excess from the rest of the other currencies, this will be levelled out as well, with some excess being moved to the Accumulator 80 because the exchange rates can be made favourable to the levelling and the GFCG 100. In this particular example of FIG. 6, there are 965.938 EURO excess being taken off and absorbed by the Accumulator 80.

It should be noted that in the real situation the VCUs can only be bought or sold one trade after another, sequentially and not concurrently. FIG. 6 is only an example to show how the base Grid 270 value is created. The excess value of 965.938 EURO may not have been the final result because the sequence will affect the type of excess fiat currency to be taken off from the GFCG 100.

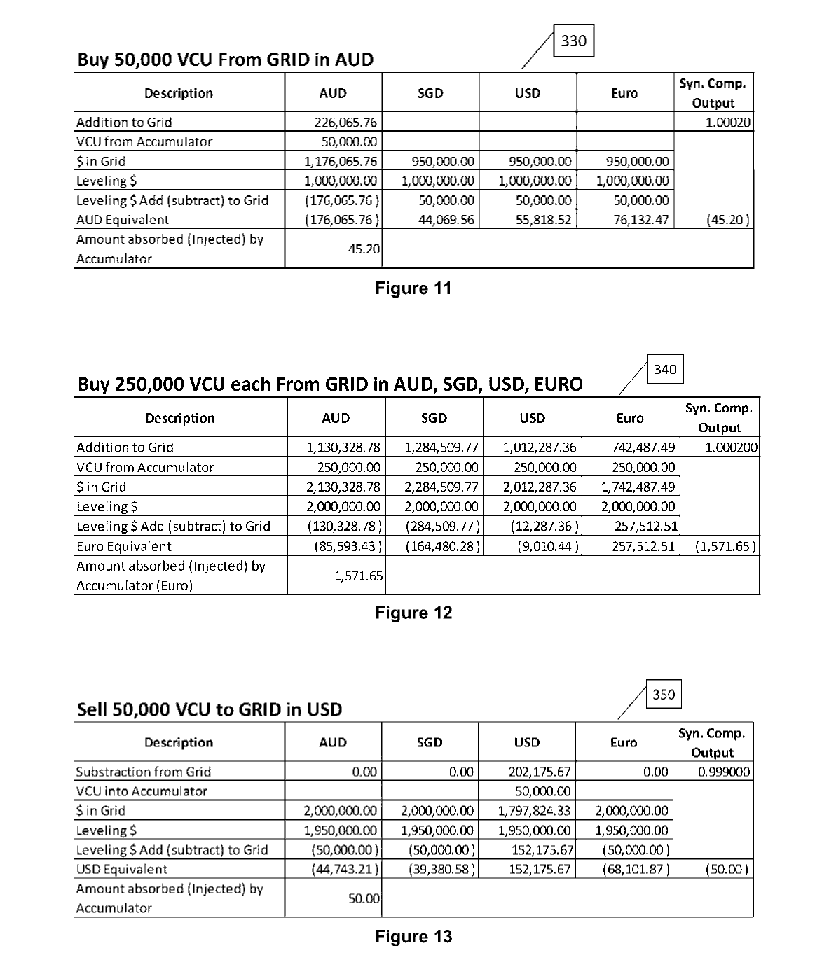

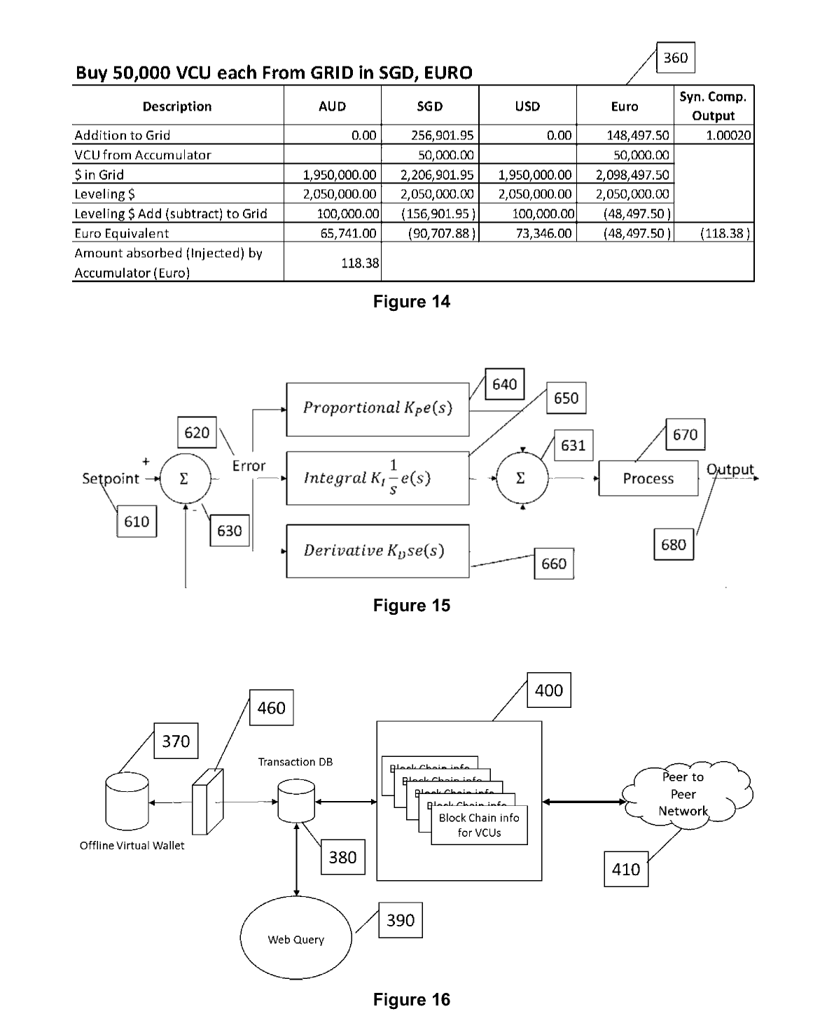

FIGS. 10, 11, 12, 13, and 14 are sequential examples to show what the movements are like as VCUs are bought and sold off the GFCG 100. It should be noted that the value of the cross currency exchange rates are all assumed to remain constant in all the trades. In a live situation, this will not be the case as the Forward Cross Currency Exchange Rates 300 and Reverse Cross Currency Exchange Rates 310 will always be changing. The VCU value with respect to each currency will therefore fluctuate and in accordance to their relative ratios in the grid.

This virtual currency is based on a zero sum logic of all the world's currency exchange rates put together. A rise in some currencies will see a fall in others. All fiat currencies relate to one another and because they relate to one another, the differential sum of all these currencies with respect to their price against each VCU should add up to nearly the same irrespective of how they vary against each other.

Having now shown how the VCU value is derived, it can be seen how the VCU can be used as a tool for hedging rather than having to hedge itself onto something. In fact, it is a very good tool for hedging.

As an example, say, 1 virtual currency unit (VCU) is equivalent to 1.25GBP. If an entity decides that it needs 1,250GBP three months from now and wants to hedge to make sure that it does not lose out, it buys a put option for the right to sell 1000 VCUs at 1.25GBP each. Subsequently, if the GBP appreciated against the VCU, the entity may either exercise the put option or decide to convert to some other currency that has a better deal. For example, if the VCU at that time was 2 USD each and the USD:GBP cross exchange rate was 1:0.65, then the entity will stand to save 38.46154 VCU which could very well be less than the cost of hedging.

The foregoing example has given rise to another dimension in which an entity will stand to gain from holding VCU. It acts like a hub to a myriad of options through its spokes which are all the fiat currencies in the GFCG 100. In the first instance, the entity is protected. In the second instance, the entity has the option to convert the VCU into another currency before being finally converted to GBP and at a gain.

Hence, if the GFCG 100 base is sufficiently large, this can prove to be a very reliable and stable tool for the financial industry as they should not expect too much variation, especially in the absolute value of the VCU itself. By holding VCUs, an entity can possibly find one currency that is favourable against the target currency that it chooses to convert to at a later date. The only caveat is that the target currency has risen above all the rest of the currencies and its weight has impacted the value of the VCU against it. Most importantly, it must be stressed here that the entire GFCGE 50 is a real-time system and therefore provides instant trading conditions. More sophisticated secondary derivatives can be created (perhaps at cheaper costs because of the convenience) to hedge on these currencies.

FIG. 16 shows how a Virtual Wallet 370 will interact with the network to manage the VCUs in circulation. The Virtual Wallet 370, which includes data indicative of a number of VCUs, is always offline and is protected by a Firewall 460. In some cases, it may need to connect to the network to synchronise. The transaction database 380 is always querying the distributed public ledger or Block Chain data 400 for any transactions and updates itself on the records of where these transactions are. The Block Chain 400 contains public information and sits on the Internet 410 hosted by all the miners in a peer-to-peer network.

A Web Query 390 provides a window for the administrator to see what the state is like on the VCUs in circulation, as well as the data indicative of the balance in the Virtual Wallet 370. The balance shall be used for proof checks by the Accumulator 80.

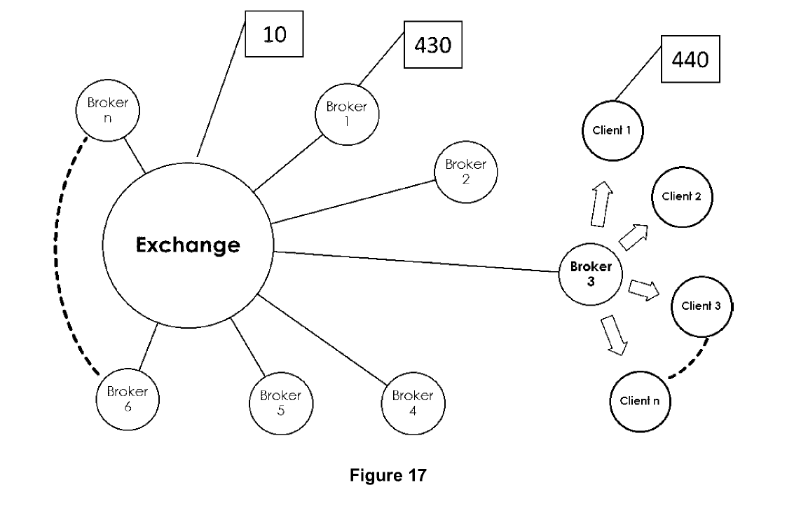

FIG. 17 is a diagram showing how the VCUs are being traded in an Exchange 10. Prices are pumped in from the Market Maker Engine 90 that is fed through from the GCFG 100. Prices are influenced by the pricing matrix of cross currency exchange rates. The Market Maker Engine 90 gets its pricing from the GFCG 100 which in turn, is controlled by the Synchronous Compensator 70.

As the Market Maker Engine 90 determines the market pricing, there leaves not much room for manipulation by anyone and therefore is not meant for speculation. In fact, it is an instrument that should be used for benchmarking.

The Exchange 10, in one embodiment, shall be independently run and subscribed by various channels. These channels, being Brokers 430, can consist of Banks or financial institutions, payment processor gateways, money changers, trading brokers and credit companies.

Each of these Brokers 430 in turn, will have their own set of clients 440 including retail, merchant or service providers which make use of the services to facilitate their commerce and trading. Brokers are channels with physical presence and should be located everywhere, in any locality, so long that they can meet local requirements and regulations.

The philosophy of going through Brokers 430 and channels is to make the VCU as pervasive and accessible as possible. The distribution of VCUs should be made easy. Likewise, the usage should also be made easy. No one should be worried about how the VCUs are being generated and managed, so long they know that at the end of the day, the value of the VCU is worth as much as what the published price suggests.

This distribution method requires that the end user or anyone who needs to store the VCU have a virtual wallet to store information and data relating to the VCU. The system therefore, is not a deposit holding system but more so a system, that sells the VCUs to anyone who needs them and will agree to buy them back at the quoted price in the Exchange 10. In one embodiment, it is a contract, more specifically, a bearer contract between a buyer and the system. The buyer can choose to exchange a VCU with anyone who accepts it. The contract entitles the bearer of this contract to exchange the VCU for any fiat currency in the GFCG 100 the bearer chooses and at the exchange rate that is published in the Exchange 10. The bearer will of course need to open an account with a bank in order to receive fiat currency. Hence, checking money laundering or any other activities that are illegal, unless it is exchanged for cash which may be hard to trace, but is easier to trace than cash transactions. The eco-system can be configured to include an offline transaction history record independently. Additionally, virtual wallets can be serialised and marked to track users of the VCUs.

The various aspects of the invention as described above are all implemented with computer technologies. In particular, these computer technologies at least include some combination of cryptocurrency technology, Internet technologies, and computer systems having databases, and specially designed applications and software systems. The computer technologies are integral to the operation and implementation of the eco-system as herein described which relates to creating, managing and facilitating transaction services of a virtual currency. Furthermore, the computer technologies are central to carrying out the functions, including automated functions, of the invention.

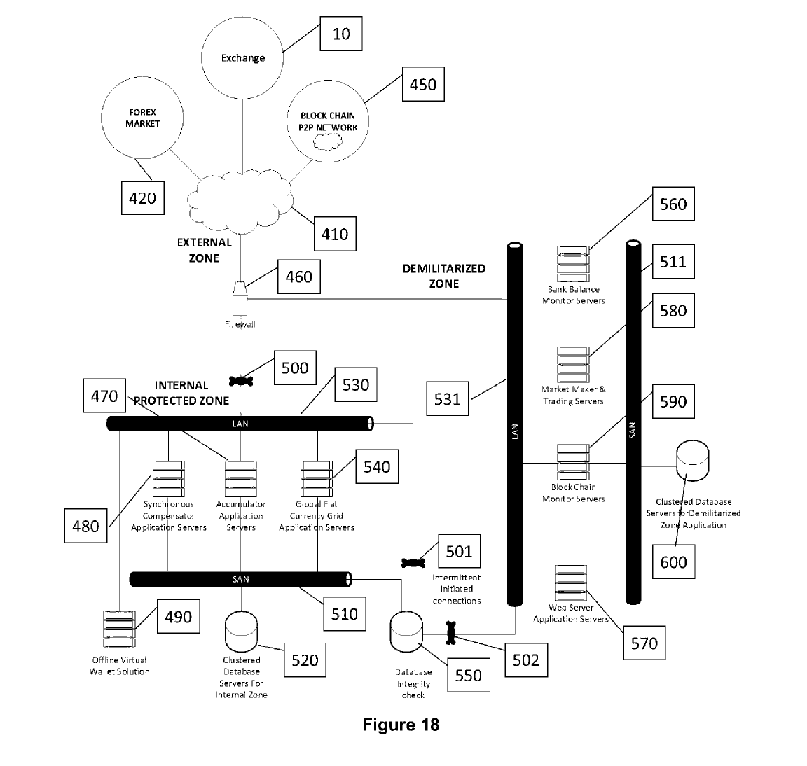

FIG. 18 is a network diagram showing hardware and system architecture in which the entire computer implemented eco-system is hosted according to one embodiment. It consists of firewalls, routers, switches and servers, each with their own set of Central Processing Units (CPUs), random access memories, EEPROM, Flash Memory, requisite amount of data storage in any definable and usable medium that suits the embodiment, operating systems, software, application programs and/or database programs to carry out their respective specialised tasks in a highly redundant design that can be distributed and with hot standby switch overs in the event of system failures. This is one method of configuration but it will be appreciated by those skilled in the art that there are other ways to configure the network and solution to suit the requirements of the computer implemented eco-system of the invention.

FIG. 18 includes, at a minimum, the following features:
1. An external Exchange 10—An external exchange is required to complete the offering so that the Market Maker Application Servers 580 can offer for trade, the Virtual Currency Units
2. A Foreign Exchange Market 420—The entire solution needs to trade with a FOREX Market 420 during the normalisation process in order to make sure there is no exposure to any Forex risk. Real-time Forward and Reverse Cross Currency Exchange Rates data are fed live from the Forex Exchange 420 into the Market Maker and Trading Exchange servers 580. Likewise, the Market Maker and Trading Exchange servers 580 trade directly with the Forex Exchange 420 under real-time, direct “instructions” from the Accumulator Application Servers 470.
3. A Distributed Public Ledger or Block Chain Peer-to-Peer (P2P) network 450—The Distributed Public Ledger or Block Chain Network 450, as detailed in the foregoing. Each host in the peer-to-peer network signs transactions and hosts a decentralised and Distributed Public Ledger or Block chain 400 database that synchronises on the peer-to-peer network and ensures that the Ledger is up to date with the database of the block chains and their transactions and records.
4. Internet Connectivity 410—Requires Internet Connectivity as a means of communication with the world at large.
5. Firewall Solution 460—A comprehensive firewall solution is put into place that includes management of Distributed Denial of Service attacks and sophisticated Intrusion Prevention, and other solutions to prevent other attacks.
6. Intermittent Connectivity Algorithm 500, 501 and 502 in place—An algorithm put in place for certain servers to shut themselves off from connecting to the Network when not necessary. In one embodiment, this is a timed event and essentially acts as a blocking router that closes all ports, goes into stealth mode and wakes up at a particular time that is set by the administrator or by the system.
7. Local Area Network 530 and 531—Local Area Networks serviced by high speed switching fabric core switches to connect servers together.
8. Synchronous Compensator Application Servers 480—Set of Application Servers to do the necessary Control of pricing as detailed in the foregoing. They shall run on a highly redundant configuration to ensure that there is no single point of failure.
9. Accumulator Application Servers 470—Set of redundant application servers to manage the accounting, control and management of both Fiat Currencies and Virtual Currency units as detailed in the foregoing.
10. Global Fiat Currency Grid Application Servers 540—Set of redundant application servers to manage the Global Fiat Currency Grid and its Grid Currency Components as described in the foregoing.
11. Offline Virtual Wallet Management Solution 490—Solution to Manage data indicative of the Virtual Currency Units. They shall be highly secure and require one or more signatories to release any VCUs into the VCCP 110.
12. Clustered Database Servers for Internal Zone 520—Database Servers to serve all the application servers in the Internal Protected Zone. The configuration shall be redundant with auto failover to ensure continuity.
13. Fibre Switched Fabric Storage Area Network 510 and 511—Database Servers are serviced by a Fibre-connected Network.
14. Database Integrity Check Server 550—An offline stealth mode checker for data integrity to ensure that the systems are not affected by any hacking and infiltration activities. This server checks and compares all the databases to ensure that there are no anomalies.
15. Bank Balance Monitor Servers 560—A set of servers to monitor real time fiat currency standing in all the currencies that the Fiat Currency Grid deals with. These balances are passed on to the Accumulator Application Servers 480 for them to reconcile the information with the rest of the information as mentioned in the foregoing.
16. Market Maker Trading Servers 580—Price quotation management and trading coordinator for Market Making of VCUs. It also does the trading of actual fiat currency pairs with a Forex Market to balance up the fiat currencies in the GFCG 100. Additionally, it receives live feeds of data relating to Forex Cross Currency Exchange rates to be fed into the GFCG 100.
17. Block Chain Monitor Servers 590—Monitors Block chains or ledgers and tracks transactions throughout. They communicate with the peer-to-peer network to ensure that transaction data are in check.
18. Clustered Database Servers 600 for Demilitarized zone—Database Servers to serve all the application servers in the Demilitarized Zone. They are configured with redundancy and are always in a hot-standby.
19. Web Server Applications 570—Information and news update dissemination pertaining to the entire operations, events, pricing, etc.

This disclosure gives rise to the emergence of VCUs being an important financial instrument whereby it can be used for all commerce, trade and finance. In particular, the disclosure details the computer implemented frameworks, and methods configured to create, manage and facilitate transaction services of these VCUs. The VCUs can be used as a medium of International exchange. International loans can be disbursed in VCUs. Borrowers can rest assured that the money they borrow can remain reasonably stable throughout and therefore able to carry out their business without too much risk. Embodiments of the invention additionally give rise to the VCUs being made a financial instrument where fiat currencies can benchmark their exchange rates.

In the local front, banks and other financial institution can make use of the VCU in extending local loans to borrowers. Borrowers can opt to pay in VCU or in the local currency depending on which is more advantageous to them and depending on their holding position in either currencies or their business activities. Additionally, local banks can hold some of these funds for themselves to conduct business such as issuing VCU credit cards whereby they can extend credits to consumers and fund their international purchases of goods and services on credit. Merchants that wish to trade internationally can make use of VCU as a medium of exchange, knowing that they can bank with their local banks using VCUs. Local businesses with physical shop fronts can also accept VCUs from local or foreign visitors. All this can only add to the advantage of doing business at a lesser cost.

International transfer of funds is instantaneous and cuts out all intermediaries, thereby reducing the cost of transfer. Recipients can keep the funds in their virtual wallets until they use it in exchange for the local currency. Additionally, if merchants and various outlets begin to accept in VCUs there isn't much need to exchange them for local currencies. The VCU accordingly to embodiments of the invention, is extremely versatile, universal, and pervasive.

This disclosure explicitly details the use of such a process to make it all come together and work as a computer implemented eco-system. The concept of having a near zero differential sum set of cross-currency exchange rate financial instruments, and in this case, using an extrinsically valued set of fiat currencies that are almost completely balanced in a grid matrix, does not mean that it is only limited to fiat currencies. The concept shall include financial instruments that have the capability to come to near zero differential sum gains in some worked out ratios in a grid matrix. For example, the grid matrix may include commodities such as gold, securities, derivatives, indices, etc., so long that this grid matrix does not change substantially in its normalised value on a per unit basis warrants it to follow the concept in which embodiments of this invention is built upon.

The GFCGE 50 itself is an invention that is unique. It merges the technological world of electrical engineering into the financial world. It is self-adjusting where one can base the computer implemented algorithm on control or mathematical theory to manage the price of each VCU against any currency in the GFCG 100. The Accumulator 80 works on both VCUs and fiat currencies to add or subtract these currencies from the GFCG 100 or VCCP 110.

Today, the global financial situation is highly turbulent. Fluctuating differentials can be huge and often damaging to any business or the financial world. We have seen enough of this in the current century and it shall continue to be a feature. This is so because of the use of highly advanced technology in the financial industry that works at Internet speed. It is therefore timely that this invention will help as a damper on the wildly fluctuating currencies in the financial industry. In fact, the potential stability of the VCU is a good case for it to become a global reserve currency. The very existence of the VCU that can be made into an independent financial instrument allows it to be decoupled from the GFCG 100. The entire system design makes decoupling and recoupling so easy, invisible, seamless and independent of one another.

While there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A computer implemented method for managing a virtual currency transaction, the method including:
maintaining access to data indicative of a real-currency reservoir, wherein the data indicates values held in each of a defined set of N currencies, wherein at a given point in time, M normalised units are held respectively for each of the N currencies;
receiving data indicative of a transaction in a given one of the currencies Y, wherein the transaction has a value of X in currency Y, wherein the transaction increases the value held in currency Y from M normalised units to M+i normalised units;
determining a series of transactions thereby to balance the real-currency reservoir, such that a portion of the i normalised units of currency Y are converted into others of the N currencies, thereby enabling automatic balancing of the real-currency reservoir such that M+j normalised units are held respectively for each of the N currencies; and providing an instruction to execute the series of transactions.

2. A method according to claim 1 wherein X and i are positive values, such that the transaction is a purchase of virtual currency for consideration of X value in currency Y.

3. A method according to claim 1 wherein X and i are negative values, such that the transaction is a buyback of real currency of X value in currency Y for consideration of virtual currency.

4. A method according to claim 1 including allocating, in respect of the transaction, a value in virtual currency determined based on a current virtual currency normalised exchange rate for currency Y.

5. A method according to claim 1 wherein, for each currency in the set of N currencies, a single normalised unit corresponds to a single integer standard currency value.

6. A computer implemented system for automatically pricing a virtual currency unit including:
a real-currency reservoir including data indicative of a defined set of N currencies each having a value, the real-currency reservoir configured to receive input data from a synchronous compensator and provide output data indicative of the pricing of the virtual currency unit with respect to any one of the N currencies;
a sensor configured to retrieve the data value of each of the N currencies from the real-currency reservoir output, and providing the data value of each of the N currencies as feedback in the form of data indicative of a measured sensor output;
wherein the data indicative of the measured sensor output is compared with a corresponding reference data value to provide a measured data error, the reference data value including an absolute or relative re-time data value of each of the N currencies;
wherein the synchronous compensator is configured to receive the measured data error and convert the measured data error into the input data for the real-currency reservoir.

7. A system according to claim 6 wherein the synchronous compensator uses amplification and filtration to convert the measured data error into input data for the real-currency reservoir.

8. A system according to claim 6 wherein the real-currency reservoir is normalised to contain an equal number of units and fraction thereof of each of the N currencies, and the number of virtual currency units and fraction thereof is the same as the number of each of the N currencies.

9. A system according to claim 6 wherein the real-currency reservoir is configured to level the number of units of each of the N currencies following a transaction, such that the number of units of each of the N currencies always remains the same as the number of virtual currency units.

10. A system according to claim 6 wherein the reference data value is obtained from a real time and dynamic feed.

11. A system according to claim 6 wherein the synchronous compensator uses established math or control theory or machine learning or statistical modelling.

12. (canceled)

13. (canceled)

14. A non-transitive carrier medium carrying computer executable code that, when executed on a processor, causes the processor to:
maintain access to data indicative of a real-currency reservoir, wherein the data indicates values held in each of a defined set of N currencies, wherein at a given point in time, M normalised units are held respectively for each of the N currencies;
receive data indicative of a transaction in a given one of the currencies Y, wherein the transaction has a value of X in currency Y, wherein the transaction increases the value held in currency Y from M normalised units to M+i normalised units;
determine a series of transactions thereby to balance the real-currency reservoir, such that a portion of the i normalised units of currency Y are converted into others of the N currencies, thereby enabling automatic balancing of the real-currency reservoir such that M+j normalised units are held respectively for each of the N currencies; and providing an instruction to execute the series of transactions.

15. A non-transitive carrier medium according to claim 14 wherein the computer executable code causes the processor to use positive values for X and i, such that the transaction is a purchase of virtual currency for consideration of X value in currency Y.

16. A method according to claim 1 wherein the computer executable code causes the processor to use negative values for X and i, such that the transaction is a buyback of real currency of X value in currency Y for consideration of virtual currency.

17. A method according to claim 1 wherein the computer executable code further causes the processor to: allocate, in respect of the transaction, a value in virtual currency determined based on a current virtual currency normalised exchange rate for currency Y.

18. A computer system configured to:
maintain access to data indicative of a real-currency reservoir, wherein the data indicates values held in each of a defined set of N currencies, wherein at a given point in time, M normalized units are held respectively for each of the N currencies;
receive data indicative of a transaction in a given one of the currencies Y, wherein the transaction has a value of X in currency Y, wherein the transaction increases the value held in currency Y from M normalized units to M+i normalized units;
determine a series of transactions thereby to balance the real-currency reservoir, such that a portion of the i normalized units of currency Y are converted into others of the N currencies, thereby enabling automatic balancing of the real-currency reservoir such that M+j normalized units are held respectively for each of the N currencies; and providing an instruction to execute the series of transactions.

19. A computer system according to claim 18, further configured to: to use positive values for X and i, such that the transaction is a purchase of virtual currency for consideration of X value in currency Y.

20. A computer system according to claim 18, further configured to: use negative values for X and i, such that the transaction is a buyback of real currency of X value in currency Y for consideration of virtual currency.

21. A computer system according to claim 18, further configured to: allocate, in respect of the transaction, a value in virtual currency determined based on a current virtual currency normalized exchange rate for currency Y.
